(19) United States
(12) Patent Application Publication
(10) Pub. No.: US 2009/0022482 A1
(43) Pub. Date: Jan. 22, 2009

(54) Optical disc reproducing apparatus

(76) Inventor: Toshihiro Nishikawa, Osaka (JP)

Correspondence Address: MORGAN LEWIS & BOCKIUS LLP, 1111 PENNSYLVANIA AVENUE NW, WASHINGTON, DC, 20004, US

(21) Appl. No.: 12/219,296

(22) Filed: Jul. 18, 2008

(30) Foreign Application Priority Data
Jul. 20, 2007 (JP) 2007-189937

(51) Int. Cl. H04N 5/00

(52) U.S. Cl. 386/126; 386/E05.064

(57) ABSTRACT

The image signal superimposing portion generates an image signal for displaying images in a superimposed manner by using at least three layers, i.e., first to third layers. A main moving image is displayed in the first layer. A still image generated by an OSD generating portion is displayed in the second layer. A sub moving image having a display size smaller than that of the main moving image is displayed accessorily in the third layer. The first layer is displayed below the second layer, and the second layer is displayed below the third layer. The image signal superimposing portion superimposes these three layers of images so as to generate a single hierarchical image signal. When a hiding instruction receiving portion receives a hiding instruction, the hiding portion generates an opaque color image in the second layer by using the OSD generating portion so that the main moving image displayed on a layer below an OSD layer becomes invisible.

This application is based on Japanese Patent Application No. 2007-189937 filed on Jul. 20, 2007, and the contents of which are hereby incorporated by reference.

### BACKGROUND OF THE INVENTION

1. Field of the Invention

The present invention relates to an optical disc reproducing apparatus capable of reproducing a plurality of moving images that are overlaid in a hierarchical manner. In particular, the present invention relates to an optical disc reproducing apparatus capable of displaying a specific layer of moving image in an emphasized manner.

2. Description of Related Art

Recently, a large capacity optical disc such as a BD (Blu-ray Disc) or an HD-DVD (High-Definition Digital Versatile Disc) is being available as the next generation of optical disc following a DVD (Digital Versatile Disk). The next-generation optical disc has not only storage capacity larger than the DVD but also various functions that are not provided to the DVD.

One of these functions is a function of displaying a plurality of moving images overlaid in a hierarchical manner (hereinafter referred to as a “hierarchical display function”). This function is performed, for instance, by using a layer for displaying a “Primary Video” (i.e., a main moving image) (hereinafter referred to as a “main moving image layer”) and a layer for displaying a “Secondary Video” (i.e., a sub moving image) (hereinafter referred to as a “sub moving image layer”), which are defined in the standard of BD. If individual moving images are displayed in these two layers, a user can view a plurality of moving images at the same time.

However, it is possible to consider a situation where the user wants to view only one of the plurality of moving images while the user is using the hierarchical display function. If the user wants to view only the main moving image, the user should turn off the hierarchical display function. But if the user wants to view only the sub moving image, it is difficult conventionally to turn off the display of the main moving image. This is because that the main moving image is processed preferentially to the sub moving image in the hierarchical display function, and that there is not a function of turning off the display of the single main moving image. Therefore, if the display of the main moving image is stopped, the display of the sub moving image is also stopped.

The hierarchical display function has a merit that a quantity of information capable of being displayed on one screen is large, but it also has a demerit that the screen becomes complicated so that it is difficult for the user to concentrate on viewing the predetermined moving image. In this situation, it is a problem of low usability that the user cannot select only one of the main moving image and the sub moving image for viewing.

Concerning the problem described above, JP-A-2007-028524 discloses an image reproducing apparatus that is capable of displaying OSD (On Screen Display) data appropriately even in the case where an automatic widening function of the display apparatus is used. This image reproducing apparatus reproduces the image signal including a main image and a sub image so as to output as a display and outputs OSD data of predetermined information as a display. Furthermore, this image signal is a wide-screen supporting signal, and the OSD data is displayed in a sub image region when the sub image is displayed under the main image.

In addition, concerning the problem described above, JP-A-2006-301163 discloses an image synthesizing apparatus that reads the main image data, the sub image data and the OSD data sequentially and synthesize them to be output, in which a quantity of data to be transferred and synthesized is reduced, and power consumption is also reduced. This image synthesizing apparatus includes an image data synthesizing portion, a storage control portion for storing the synthesized image data in a memory portion, and a selector portion for selecting synthesized image data output from the image data synthesizing portion or synthesized image data read out from the memory portion so as to output the selected image data. This selector portion has a feature of selecting the synthesized image data read out from the memory portion if input image data does not change between consecutive images.

However, although the image reproducing apparatus disclosed in JP-A-2007-028524 described above can make the plurality of images displayed in a hierarchical manner be easily viewed, it is concerning the reproducing apparatus on a basis of the DVD standard. There is a limitation in the DVD that although it can display a still image in a hierarchical manner, but it can display only one layer of a moving image. Therefore, besides the moving image layer, only the still image can be displayed. In addition, although the above-mentioned JP-A-2006-301163 discloses reductions of a quantity of transferring synthesized data and power consumption concerning the process, it is concerning the image synthesizing apparatus. Therefore, it cannot be applied to a reproducing apparatus that does not have the image synthesizing function, and it cannot perform control for the user to view only a specific layer of moving image.

### SUMMARY OF THE INVENTION

It is an object of the present invention is to provide an optical disc reproducing apparatus that is capable of hiding the main moving image so as to select the sub moving image and instructing to display the selected sub moving image in an emphasized manner when the user wants to concentrate on viewing the sub moving image.

An optical disc reproducing apparatus according to the present invention includes a control portion, an image signal generating portion for generating an image signal, and an image signal superimposing portion for generating a hierarchical image signal for displaying a plurality of images overlaid in a hierarchical manner from a plurality of image signals. The image signal superimposing portion generates the hierarchical image signal for displaying an image having a hierarchical structure including a first layer for displaying a first moving image, a second layer for displaying the image generated by the image signal generating portion, and a third layer for displaying a second moving image having a display size smaller than that of the first moving image, the first layer being disposed below the second layer and the second layer being disposed below the third layer, and the control portion includes a hiding instruction receiving portion for receiving an instruction to hide the first moving image, and a hiding portion for generating an image signal for displaying an opaque color image by using the image generating portion when the hiding instruction receiving portion receives the hiding instruction.

According to this structure, the optical disc reproducing apparatus of the present invention includes a control portion, an OSD generating portion for generating an image signal (i.e., the image signal generating portion), and the image signal superimposing portion for generating a hierarchical image signal for displaying a plurality of images overlaid in a hierarchical manner from a plurality of image signals. The image signal superimposing portion generates the hierarchical image signal by using at least three layers, i.e., first to third layers. A main moving image (i.e., a first moving image) is displayed in the first layer. A still image generated by the OSD generating portion is displayed in the second layer. A sub moving image (i.e., a second moving image) having a display size smaller than that of the main moving image is displayed accessorily in the third layer. The first layer is displayed below the second layer, and the second layer is displayed below the third layer. The image signal superimposing portion generates the hierarchical image signal for displaying these three layers of images in a superimposed manner.

In addition, the control portion includes a hiding instruction receiving portion and a hiding portion. The hiding instruction receiving portion receives a hiding instruction to hide the main moving image from a user. When the hiding instruction receiving portion receives the hiding instruction, the hiding portion generates an opaque color image in the second layer by using the OSD generating portion. Thus, the image in the first layer included in the hierarchical image signal generated by the image signal superimposing portion, i.e., the main moving image becomes in an invisible state for the user.

In addition, as to the optical disc reproducing apparatus of the present invention, when the hiding instruction receiving portion receives the hiding instruction, the hiding portion generates an image signal for display an translucent color image in the second layer by using the image generating portion.

According to this structure of the optical disc reproducing apparatus of the present invention, when the hiding instruction receiving portion receives the hiding instruction, the hiding portion generates the translucent color image in the second layer by using the OSD generating portion. Thus, the image in the first layer included in the hierarchical image signal generated by the image signal superimposing portion, i.e., the main moving image is hidden partially as a translucent image. In this way, the main moving image can be displayed in a hazy manner, for instance.

In addition, as to the optical disc reproducing apparatus of the present invention, the optical disc is a BD, and the image signal superimposing portion uses a layer for displaying a Primary Video in the BD standard as the first layer and uses a layer for displaying a Secondary Video in the BD standard as the third layer.

According to this structure of the optical disc reproducing apparatus of the present invention, a BD is used as the optical disc for reproducing information. The standard of BD defines a main moving image called a Primary Video and a sub moving image called a Secondary Video, and these two images can be reproduced in a superimposed manner by using individual layers. Therefore, the hiding function of the present invention can be realized by disposing an OSD layer between the layer for displaying the Primary Video and the layer for displaying the Secondary Video.

In addition, as to the optical disc reproducing apparatus of the present invention, the image signal superimposing portion generates the hierarchical image signal for displaying the first moving image on the entire screen of a display apparatus connected to the optical disc reproducing apparatus and for displaying the second moving image on a part of the screen of the display apparatus.

According to this structure, the main moving image has a size to be displayed in the entire screen of a display apparatus, and the sub moving image has a size to be displayed on a part of the screen of the display apparatus. Therefore, even if the sub moving image is displayed in a superimposed manner on the main moving image, the user can view both of them at the same time.

In addition, as to the optical disc reproducing apparatus of the present invention, the image signal superimposing portion generates the hierarchical image signal by using a reduced moving image obtained by a reducing process of a moving image as the second moving image.

According to this structure, a reduced moving image obtained by a reducing process of a predetermined image is used as the sub moving image. For instance, therefore, it is possible to view the two moving images included in the BD at the same time if one of them is displayed normally as the main moving image while the other is displayed in a reduced manner as the sub moving image.

According to the present invention described above, the main moving image that cannot usually be stopped to display by itself can be in a non-display state while only the sub moving image can be in a display state. Therefore, when the user want to view only the sub moving image without the main moving image, the user can view only the sub moving image easily by operating the selector button or the like.

In addition, according to the present invention, the user can concentrate on viewing the sub moving image and can view the contents of the main moving image at a minimum ratio. Therefore, for instance, until the main moving image comes to a specific scene, or until commercials in the main moving image ends, the user can concentrate on viewing the sub moving image while checking the contents of the main moving image if he or she wants to do that.

In addition, according to the present invention, it is possible to utilize a superimposed display function that is provided to the BD player in advance, so that cost for preparing a processor for the superimposed display, e.g., an LSI chip can be reduced.

In addition, according to the present invention, since the main moving image has a larger size than the sub moving image, the hiding process of the present invention can be performed more effectively.

In addition, according to the present invention, it is possible to display one of the two moving images included in a BD as the main moving image and to display the other in a reduced manner as the sub moving image, for instance, so that two of them can be viewed at the same time. Therefore, the user can select appropriately one of the main moving image and the sub moving image that the user want to view intensively.

### BRIEF DESCRIPTION OF THE DRAWINGS

FIG. 1 is a functional block diagram illustrating a structure of functional portions included in an optical disc reproducing apparatus of the present invention.

FIG. 2 is a structural diagram illustrating an inside structure of the optical disc reproducing apparatus of the present invention.

FIG. 3 is a schematic diagram illustrating a hierarchical structure of an image signal generated by the image signal superimposing portion of the present invention.

FIG. 4 is a screen diagram illustrating an example of a screen displayed by the optical disc reproducing apparatus of the present invention.

FIG. 5 is a screen diagram illustrating an example of a screen displayed by the optical disc reproducing apparatus of the present invention.

FIG. 6 is a screen diagram illustrating an example of a screen displayed by the optical disc reproducing apparatus of the present invention.

FIG. 7 is a flowchart illustrating a process flow of a hiding process of the present invention.

### DETAILED DESCRIPTION OF THE PREFERRED EMBODIMENTS

Hereinafter, an embodiment of the present invention will be described with reference to the attached drawings. Note that the embodiment described below is merely an example, and the present invention is not limited to the embodiment.

(1. Inside Structure)

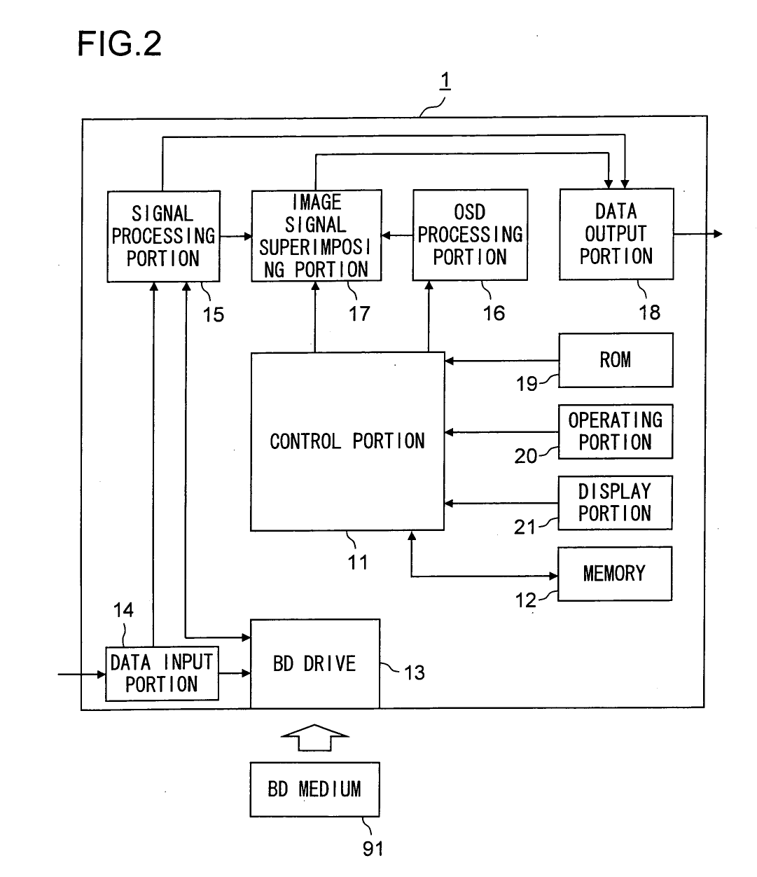

FIG. 2 is a block structural diagram illustrating a BD player 1 (i.e., the optical disc reproducing apparatus) according to an embodiment of the present invention. The BD player 1 is structured so as to include at least a control portion 11, a memory 12, a BD drive 13, a data input portion 14, a signal processing portion 15, an OSD processing portion 16 (i.e., the image signal generating portion), an image signal superimposing portion 17, a data output portion 18, a ROM 19, an operating portion 20 and a display portion 21.

The control portion 11 is a central processing unit for controlling the individual portions of the BD player 1 so as to control integrally an optical disc reproducing process, e.g., reproducing process or the like of programs recorded on a BD medium 91. The control portion 11 is made up of a plurality of processing units like microprocessors. The control portion 11 is a central portion for controlling the individual devices, e.g., the image signal superimposing portion 17 and for calculation or process of data.

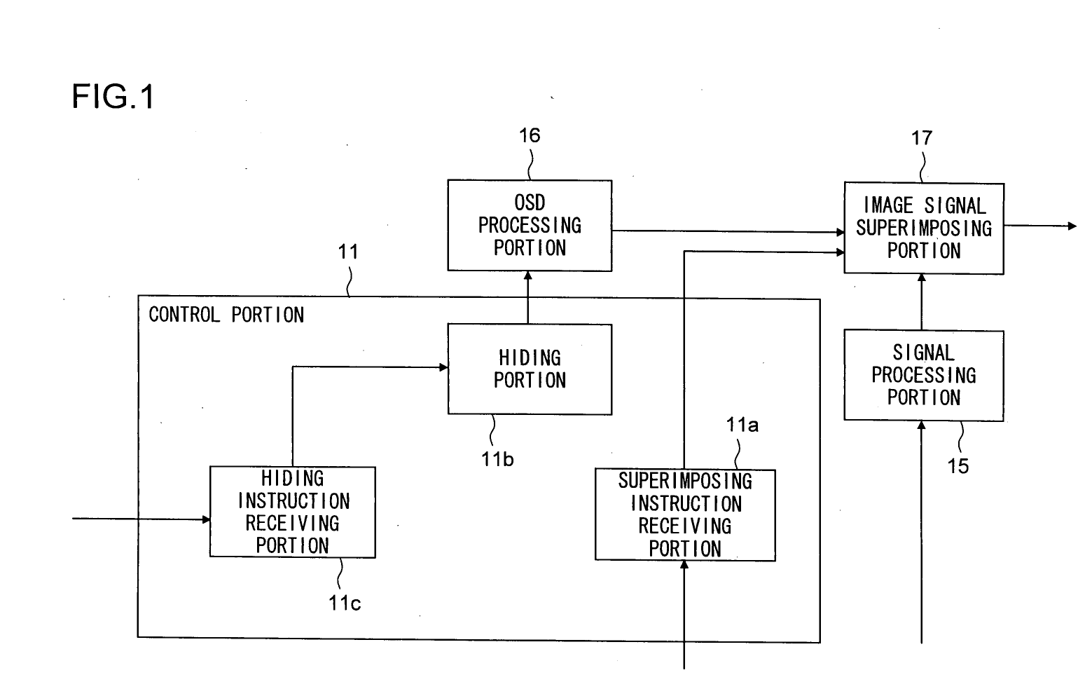

In addition, the control portion 11 includes a superimposing instruction receiving portion 11a, a hiding portion 11b and a hiding instruction receiving portion 11c shown in FIG. 1 as functional portions that are realized by executing a program on a processing unit included in the control portion 11. Note that details of these functional portions will be described later.

The memory 12 is a medium for storing temporarily various types of data kept by the BD player 1, and it is made up of a writable RAM (Random Access Memory) or the like, for instance. The memory 12 has a role as a buffer memory for storing temporarily process data when the control portion 11 performs the reproducing process or an instruction or the like received from the user, for instance.

The BD drive 13 is an optical device for reading various data optically from an optical disc such as a CD medium, a DVD medium or the BD medium 91. Note that there are a plurality of standards as the optical disc. Therefore, it is necessary to use the optical disc of the standard that the BD drive 13 supports in order to perform various processes (reproducing process and the like).

The data input portion 14 is an input interface for inputting an image signal and an audio signal from an external device such as an antenna device. In addition, it has also a role of inputting digital information that is generated by compressing the image signal or the audio signal by a specific compression method. The data input portion 14 is structured to include external connection terminals such as an RCA terminal, an S terminal and a D terminal.

The signal processing portion 15 compresses the image signal by a moving image compression method such as MPEG2 or compresses the audio signal by an audio compression method such as Dolby AC-3 or LPCM so as to generate digital information. Note that the compressing process is performed on the image signal or the audio signal supplied from the data input portion 14, for instance. In addition, the signal processing portion 15 also has a function of decoding compressed digital information supplied from the BD drive 13 or the like into the image signal and the audio signal on the contrary.

The OSD processing portion 16 generates an image signal for displaying a still image such as characters or icons. More specifically, for instance, it generates a recording reservation screen for the user to set program recording or the image signal for displaying icons or the like indicating an operating status such as fast-forward. The image signal generated by the OSD processing portion 16 is supplied to the image signal superimposing portion 17 that will be described later and is superimposed as the image in the OSD layer.

The image signal superimposing portion 17 superimposes the image signal supplied from the signal processing portion 15 with the image signal supplied from the OSD processing portion 16, so as to convert them into a primary color signal. The image signal superimposing portion 17 is realized by an integrated circuit such as an LSI chip or the like. The image signal superimposing portion 17 includes seven layers including, for instance, a background layer (1), a main moving image layer (2), a sub moving image layer (3), an inner OSD layer A (4), an inner OSD layer B (5), a local OSD layer A (6) and a local OSD layer B (7). Furthermore, images displayed in the individual layers are superimposed and are converted into a single image signal, which is supplied to the data output portion 18.

As to the image signal superimposing portion 17 of the present invention, at least one of the local OSD layer A and the local OSD layer B is disposed between the main moving image layer and the sub moving image layer. Thus, for instance, the main moving image layer (2), the local OSD layer A (6) and the sub moving image layer (3) are arranged in this order from the lower layer. Note that if the arrangement order of the three layers described above among the seven layers included in the image signal superimposing portion 17 satisfies the above-mentioned condition, an arrangement order of other layers is not limited.

The data output portion 18 is an output interface for outputting the image signal and the audio signal to the image display apparatus such as a liquid crystal monitor and an audio device such as a speaker, which are connected to the BD player 1. The ROM 19 is a recording medium capable of only reading information. The ROM 19 stores, for instance, program data for the control portion 11 to perform the image reproducing process or the like, initial setting information when the BD player 1 is hipped, and other information.

The operating portion 20 is used for the user to operate for issuing various instructions to the BD player 1, for instance, an instruction of reproducing or an instruction of selecting displays. The operating portion 20 is usually made up of a plurality of buttons including numerical buttons, cursor buttons and the like. The display portion 21 displays various information stored in the BD player 1, for instance, an operation status, reproducing time of the moving image and the like for the user. The display portion 21 is preferably a display apparatus such as a liquid crystal panel with low power consumption.

(2. Structure of Functional Portions)

Here, a relationship among the individual functional portions for performing the main moving image hiding process of the BD player 1 according to an embodiment of the present invention will be described with reference to the functional block diagram shown in FIG. 1.

As shown in FIG. 1, the main moving image hiding process of the present invention is performed by at least the superimposing instruction receiving portion 11a, the hiding portion 11b and the hiding instruction receiving portion 11c of the control portion 11, the signal processing portion 15, the OSD processing portion 16 and the image signal superimposing portion 17.

The superimposing instruction receiving portion 11a receives a predetermined operation of the operating portion 20 by the user, for instance, a superimposed display instruction issued when the sub moving image display button is pressed. As to the superimposed display, the main moving image is usually displayed on the entire screen, and the sub moving image having a size smaller than the main moving image is displayed on the main moving image. In addition, other than the main moving image and the sub moving image, an image generated by suing the OSD or the like may be displayed in a superimposed manner.

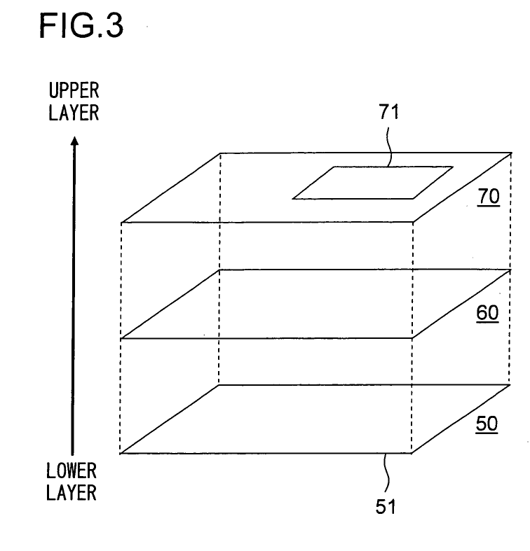

The hiding portion 11b uses the OSD processing portion 16 so as to display the hiding image of the entire screen size (i.e., the opaque color image) or the translucent image (i.e., the translucent color image) in an OSD layer 60 shown in FIG 3 that will be described later. Thus, the moving image in the layer under the OSD layer 60, for instance, a main moving image layer 50 shown in FIG. 3 cannot be viewed. Note that it is preferable to use a single color image such as a black color image or a white color image as the hiding image, but it is possible to adopt a structure in which the user can select it. In addition, it is possible to adopt a structure in which the user can set transparency of the translucent image.

The hiding instruction receiving portion 11c receives the hiding instruction to hide the main image that is issued when the user do a predetermined operation, for instance, pressing of a main moving image/sub moving image selector button by using the operating portion 20. The hiding instruction is an instruction to hide the main image so that the user can concentrate on viewing the sub image in the state where the main image and the sub image are displayed in a hierarchically superimposed manner. Receiving this instruction, the hiding instruction receiving portion 11c issues an instruction to the hiding portion 11b to display the hiding image or the translucent image in the OSD layer.

(3. Hierarchical Structure of Images)

Here, the hierarchical structure of display layers of the images in the BD player 1 according to an embodiment of the present invention will be described with reference to the schematic diagram shown in FIG. 3.

As shown in FIG. 3, the image generated by the BD player 1 of the present invention is structured to include at least three layers consisting of the main moving image layer 50 (i.e., the first layer), the OSD layer 60 (i.e., the second layer) and a sub moving image layer 70 (i.e., the third layer). Although there are other images in the background layer, the inner OSD layer and the like, which are not shown in FIG. 3, the arrangement order of these layers is not limited specifically.

The main moving image layer 50 is a layer for displaying the main moving image and corresponds to the main moving image layer (2) among the background layer (1) to the local OSD layer B (7) described above. The main moving image layer 50 is arranged below the OSD layer 60. This main moving image layer 50 is used for displaying a normal moving image that is displayed on the entire screen, for instance, a moving image that is displayed on the screen when the user instructs normal BD reproduction.

The OSD layer 60 is a layer for displaying the still image generated by the OSD processing portion 16 and corresponds to the local OSD layer A (6) and the local OSD layer B (7) among the background layer (1) to the local OSD layer B (7) described above. The OSD layer 60 is arranged above the main moving image layer 50 and below the sub moving image layer 70. This OSD layer is used for displaying a setting screen or the like for performing various settings of the BD player 1, for instance. In addition, it also has a role of displaying the hiding image or the translucent image so as to hide the image below the OSD layer.

The sub moving image layer 70 is a layer for displaying the sub moving image and corresponds to the sub moving image layer (3) among the background layer (1) to the local OSD layer B (7) described above. The sub moving image layer 70 is arranged above the OSD layer 60. This sub moving image layer 70 is used for displaying a sub moving image 71 that is a moving image having a small size displayed in a part of the screen. As the sub moving image 71, for instance, a reduced moving image generated by a reducing process of a normal moving image.

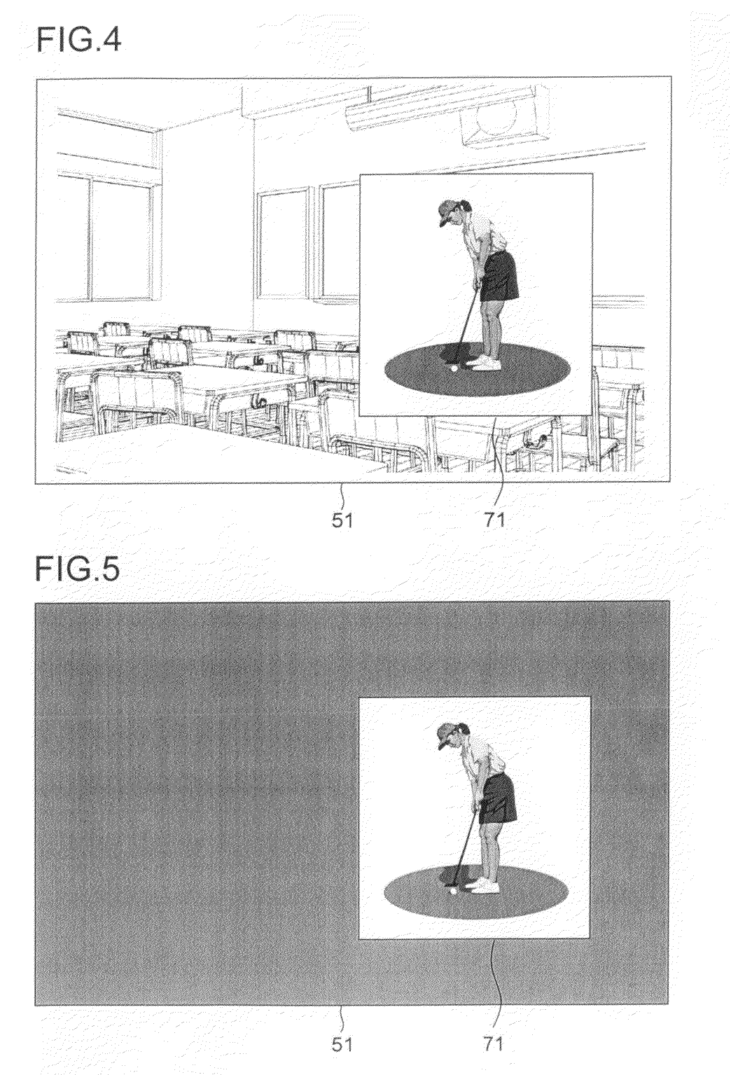

An example of a screen displaying the plurality of layers describe above in an overlaid manner on the display apparatus such as a monitor is shown in FIGS. 4 to 6. In the screen shown in FIG. 4, a main moving image 51 (i.e., a moving image of a drama in this example) is displayed in the main moving image layer 50, the sub moving image 71 (i.e., a moving image of a golf play in this example) in the sub moving image layer 70, and no image is displayed in the OSD layer 60.

Furthermore, in the screen shown in FIG. 5, the main moving image 51 is displayed in the main moving image layer 50, the sub moving image 71 is displayed in the sub moving image layer 70, and a single color image of gray color is displayed in the OSD layer 60. Since the single color image is displayed in the OSD layer 60, the main moving image 51 arranged in the main moving image layer 50 under the OSD layer 60 is hidden so that the user cannot view it. Thus, the user can concentrate on viewing the sub moving image 71 without affected by the main moving image 51.

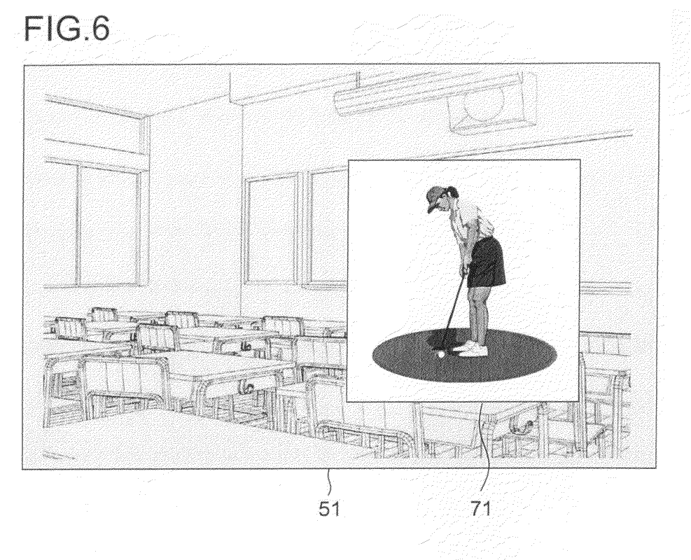

Furthermore, in the screen shown in FIG. 6, the main moving image 51 is displayed in the main moving image layer 50, the sub moving image 71 is displayed in the sub moving image layer 70, and the translucent image is displayed in the OSD layer 60. Since the translucent image is displayed in the OSD layer 60, the main moving image 51 in the main moving image layer 50 arranged below the OSD layer 60 is display only partially, so that the user cannot view it clearly. Thus, the user can concentrate on viewing the sub moving image 71 while checking contents of the main moving image 51.

(4. Superimposed Display Process of Moving Image)

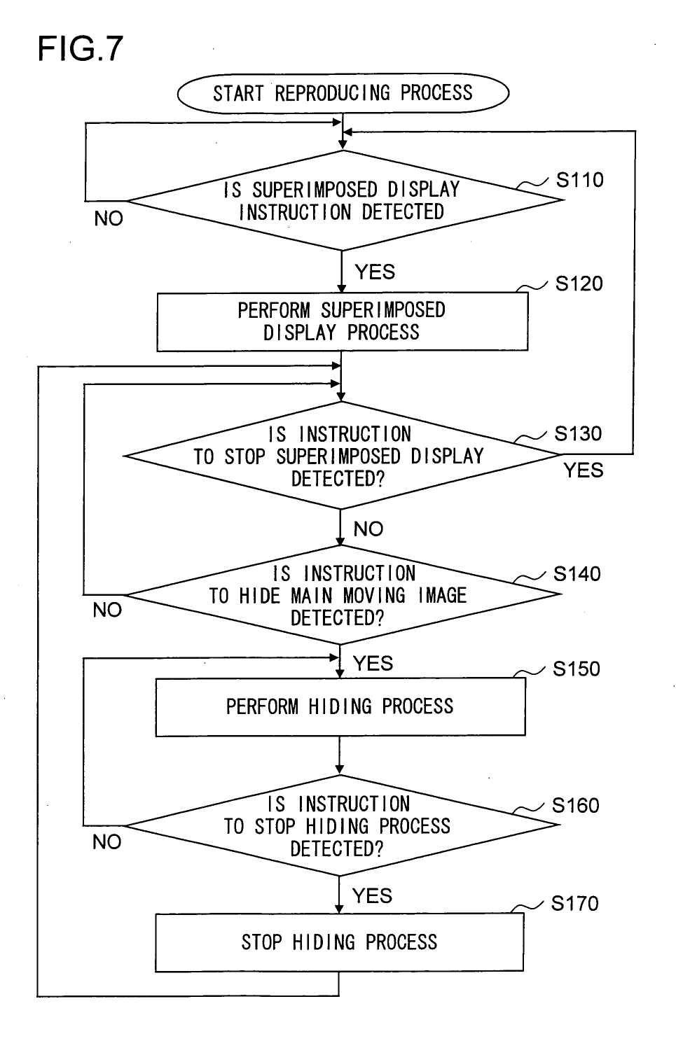

Here, the superimposed display process and the process for hiding the main moving image of the BD player 1 according to an embodiment of the present invention will be described with reference to the block diagrams shown in FIGS. 1 and 2, the schematic diagram shown in FIG. 3, the screen diagrams shown in FIGS. 4 to 6 and the flowchart shown in FIG. 7.

FIG. 7 is a flowchart showing a flow of the superimposed display process and the process for hiding the main moving image according to an embodiment of the present invention moving image. This process is started when the BD player 1 performs the reproducing process of the BD medium 91 loaded to the BD drive 13.

After this process is started, the superimposing instruction receiving portion 11a decides in step S110 whether or not the superimposed display instruction of a plurality of moving images has been received. Note that the superimposed display instruction is issued, for instance, when the user operates the operating portion 20 so as to instruct to reproduce a plurality of moving images simultaneously. If the superimposed display instruction is not detected, the process goes to the step S110 again to be in the state of waiting the superimposed display instruction.

If the superimposed display instruction is detected, the superimposing instruction receiving portion 11a instructs the image signal superimposing portion 17 in step S120 to perform the superimposed display process of the plurality of moving images. Receiving this instruction, the image signal superimposing portion 17 generates the image signal for displaying the main moving image 51 and the sub moving image 71 on the screen in a superimposed manner as shown in FIG. 4, for instance. Note that this image signal is generated by combining a plurality of image signals that are read from the BD medium 91 and are converted by the signal processing portion 15.

Next, the superimposing instruction receiving portion 11a decides in step S130 whether or not an instruction to stop the superimposed display is received. If the instruction to stop the superimposed display is received, an instruction to stop the superimposed display is issued to the image signal superimposing portion 17. Then, the process goes to the step S110 so as to be in the state of waiting the superimposed display instruction again.

If the instruction to stop the superimposed display is not received, the hiding instruction receiving portion 11c decides in step S140 whether or not the hiding instruction of the main moving image is received. Note that the hiding instruction is issued, for instance, when the user operates the operating portion 20 so as to instruct to display the sub moving image in an emphasized manner. If the hiding instruction is not detected, the process goes to the step S130 to be in the state of waiting the instruction to stop the superimposed display.

If the hiding instruction is detected, the hiding portion 11b instructs the OSD processing portion 16 in the step S150 to display the hiding image or the translucent image in the OSD layer. Receiving this instruction, the image signal superimposing portion 17 displays the single color image in the OSD layer as shown in FIG. 5, for instance. Thus, the user cannot view the main moving image 51. Alternatively, the translucent image is displayed in the OSD layer as shown in FIG. 6. Thus, the user cannot view the main moving image 51 clearly. As a result, the user can concentrate on viewing the sub moving image 71.

Next, the hiding instruction receiving portion 11c decides in step S160 whether or not the instruction to stop the hiding process is received. If the instruction to stop the hiding process is received, the hiding instruction receiving portion 11c stops the process of hiding the main moving image by the hiding portion 11b and the OSD processing portion 16 in step S170. If the instruction to stop the hiding process is not received, the process goes to the step S150, so that the hiding process is performed successively.

After performing the step S170, the control portion 11 decides again in the step S130 whether or not the instruction to stop the superimposed display is received. After that, the process of the steps S110 to S170 is performed repeatedly, so that the superimposed display process and the process of hiding the main moving image are performed successively. Note that this process is finished when an instruction to stop the reproduction or an instruction to power off the BD player 1 is issued by the user operation using the operating portion 20 or the like.

### Other Embodiments

Although the present invention is described above with reference to the preferred embodiment and examples, the present invention is not limited to the embodiment described above. The present invention can be embodied with various modifications within the scope of the technical concept thereof.

Therefore, the present invention can be applied to the embodiments described below.

(A) Although the seven layer structures including the background layer (1) to the local OSD layer B (7) are exemplified as the hierarchical structure for displaying a plurality of images by the image signal superimposing portion in the embodiment described above, other hierarchical structure having a plurality of layers may be adopted. In addition, another layer than the sub moving image layer (3) may exist for displaying the sub moving image. In this case, however, the individual sub moving image layers are required to be arranged above the OSD layer for performing the hiding process, i.e., the local OSD layer A (6) and the local OSD layer B (7).

(B) Although the OSD processing portion 16 uses the single color image or the translucent image having the entire screen size for performing the hiding process in the embodiment described above, it may use other image, for instance, a still image designated by the user in advance. In addition, the area that is to be hidden may not be the entire screen but may be limited to a peripheral area of the sub moving image.

(C) Although the single color image or the translucent image having the entire screen size used by the OSD processing portion 16 for performing the hiding process is described to be unique to the apparatus in the embodiment described above, it is possible to adopt another structure in which the user can select the image to be used from a plurality of single color images and translucent images or the user can create the image to be used. Furthermore, it is possible to adopt another structure in which transparency of the translucent image can be set. Thus, the hiding process can have variations.

(D) Although the BD player 1 is exemplified as the optical disc reproducing apparatus in the embodiment described above, the hiding process of the present invention may be applied to other optical disc apparatus having the superimposed display function. For instance, the hiding process of the present invention may also be applied to a BD-R recorder or an HD-DVD player.

(E) Although the various functional portions related to the superimposed display process and the hiding process are realized in the processing unit such as the microprocessor that executes a program in the embodiment described above, the various functional portions may be realized by a plurality of electronic circuits.

What is claimed is:

1. An optical disc reproducing apparatus comprising:
a control portion;
an image signal generating portion for generating an image signal; and
an image signal superimposing portion for generating a hierarchical image signal for displaying a plurality of images overlaid in a hierarchical manner from a plurality of image signals, wherein
the image signal superimposing portion generates the hierarchical image signal for displaying an image having a hierarchical structure including a first layer for displaying a first moving image, a second layer for displaying the image generated by the image signal generating portion, and a third layer for displaying a second moving image having a display size smaller than that of the first moving image, the first layer being disposed below the second layer and the second layer being disposed below the third layer, and
the control portion includes a hiding instruction receiving portion for receiving a hiding instruction to hide the first moving image, and a hiding portion for generating an image signal for displaying an opaque color image in the second layer by using the image generating portion when the hiding instruction receiving portion receives the hiding instruction.

2. The optical disc reproducing apparatus according to claim 1, wherein when the hiding instruction receiving portion receives the hiding instruction, the hiding portion generates an image signal for displaying a translucent color image in the second layer by using the image generating portion.

3. The optical disc reproducing apparatus according to claim 1, wherein the optical disc is a BD (Blu-ray Disc), and the image signal superimposing portion uses a layer for displaying a Primary Video defined in the BD standard as the first layer and uses a layer for displaying a Secondary Video defined in the BD standard as the third layer.

4. The optical disc reproducing apparatus according to claim 1, wherein the image signal superimposing portion generates the hierarchical image signal for displaying the first moving image on the entire screen of a display apparatus connected to the optical disc reproducing apparatus and for displaying the second moving image on a part of the screen of the display apparatus.

5. The optical disc reproducing apparatus according to claim 1, wherein the image signal superimposing portion generates the hierarchical image signal by using a reduced moving image obtained by a process reducing a moving image as the second moving image.
